(19) United States
(12) Patent Application Publication
(10) Pub. No.: US 2022/0302543 A1
(43) Pub. Date: Sep. 22, 2022

(54) APPARATUS AND METHOD FOR ASSEMBLING BATTERY MODULE

(71) Applicants: Hyundai Motor Company, Seoul (KR); Kia Corporation, Seoul (KR)

(72) Inventor: Kyungmo KIM, Hwaseong-si (KR)

(73) Assignees: Hyundai Motor Company, Seoul (KR); Kia Corporation, Seoul (KR)

(21) Appl. No.: 17/390,519

(22) Filed: Jul. 30, 2021

(30) Foreign Application Priority Data
Mar. 16, 2021 (KR) 10-2021-0033964

(51) Int. Cl. H01M 50/244; H01M 10/04; H01M 50/298; H01M 50/502; B23K 26/21

(52) U.S. Cl. CPC H01M 50/244; H01M 10/0404; H01M 50/298; H01M 50/502; B23K 26/21

(57) ABSTRACT

An apparatus of assembling a cell stack including a plurality stacked battery cells and a conduction block having a busbar electrically connected to cell leads of the plurality of battery cells may include, a jig base including a rear base and a front base integrally formed with the rear base, a bending knife which is slidably provided in the jig base, may include a frontal surface to selectively contact with at least one of the cell leads, and is elastically supported by a first plate spring formed on a first side surface of the rear base, a jig plate provided external to the jig base and configured to slide along the jig base in a front and rear direction thereof, and a bending link pivotally engaged with a frontal end portion of the jig plate and configured to rotate to be perpendicular to the jig plate while pressurizing the at least one of the cell leads.

### CROSS-REFERENCE TO RELATED APPLICATION

The present application claims priority to Korean Patent Application No. 10-2021-0033964 filed on Mar. 16, 2021, the entire contents of which is incorporated herein for all purposes by this reference.

### BACKGROUND OF THE INVENTION

### Field of the Invention

The present invention relates to an apparatus and method for assembling a battery module.

### Description of Related Art

A battery pack applied to a hybrid vehicle or an electric vehicle may be formed by combining a plurality of module assemblies in which a plurality of battery cells are stacked.

In general, in the battery pack, both end plates supporting both sides of the module assembly are fixed to the base plate to package the module assembly.

The module assembly may be formed by combining a plurality of battery cells coupled in series or in parallel.

At the present time, the module assembly forms a required capacity by assembling a required number of battery cells. For electrical connection between the battery cells, the negative electrode lead or the positive electrode lead is bent, and each bent cell lead is welded together.

The conventional assembly process includes separate processes of a process of bending each cell lead of the battery cell and a process of welding the cell leads. That is, a semi-assembly module is formed by the bending process, and then the semi-assembly module is processed for welding of the cell leads, which results in complexity of an entire process.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing an apparatus and method for assembling a battery module for simultaneously processing bending of a cell lead and welding the cell lead to a bus bar.

An apparatus of assembling a battery module is to assemble a cell stack including a plurality stacked battery cells and a conduction block having a busbar electrically connected to cell leads of the plurality of battery cells, where the apparatus include, a jig base including a rear base and a front base integrally formed with the rear base, a bending knife which is slidably provided in the jig base, may include a frontal surface to selectively contact with at least one of the cell leads, and is elastically supported by a first plate spring formed on a first side surface of the rear base, a jig plate provided external to the jig base and configured to slide along the jig base in a front and rear direction thereof, and a bending link pivotally engaged with a frontal end portion of the jig plate and configured to rotate to be perpendicular to the jig plate while pressurizing the at least one of the cell leads.

The frontal surface of the bending knife may be formed to be inclined to form a slanted surface.

The bending knife may be configured to pressurize an edge portion of the at least one of the cell leads toward the busbar by the slanted surface, by being elastically supported by the first plate spring.

The jig plate may be coupled with a coupling groove on both side surfaces of the front base by a coupling portion that integrally extends from and are bent at both sides of a body of a plate shape formed corresponding to the jig base.

The jig plate may be provided to penetrate a mounting hole formed through the rear base, through a protrusion portion formed integral with and protruding from a rear center portion of the body.

The jig plate may be elastically supported by a second plate spring formed on a second side surface of the rear base, through a supporting portion that integrally extends from and is bent at both real end portions of the body.

The bending link may be hinge-engaged with a frontal end portion of the jig plate, and forms a hollow space with respect to the frontal end portion of the jig plate.

The bending link may be configured to, when pressurizing the cell lead, rotate to be perpendicular to the jig plate by contacting with the cell lead, to allow welding of the at least one of the cell leads to the bus bar by laser beam through the hollow space.

A slot may be formed between the jig plate and the bending knife through the rear base. The hollow space and the slot of the jig base may become in-line perpendicular to the cell stack when the bending link is perpendicular to the jig plate.

The bending link may include a return spring mounted on a hinge portion between the bending link and the jig plate.

In an apparatus and method for assembling a battery module according to various exemplary embodiments of the present invention, the at least one of the cell leads of the battery cell is bent toward the busbar and forced to tightly contact with the busbar at the same time, reducing a cycle time for the welding process.

According to an apparatus and method for assembling a battery module according to various exemplary embodiments of the present invention, an overall process may be simplified, reducing investment costs and improving productivity.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates assembling of a battery module by use of an apparatus of assembling a battery module according to various exemplary embodiments of the present invention.

FIG. 2 is a schematic diagram showing a first side of an apparatus of assembling a battery module according to various exemplary embodiments of the present invention.

FIG. 3 is a schematic diagram of an opposite side of an apparatus of assembling a battery module according to various exemplary embodiments of the present invention.

FIG. 4 is a drawing showing a method for assembling a battery module according to various exemplary embodiments of the present invention.

It may be understood that the appended drawings are not necessarily to scale, presenting a somewhat simplified representation of various features illustrative of the basic principles of the invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments of the present invention, it will be understood that the present description is not intended to limit the invention(s) to those exemplary embodiments. On the other hand, the invention(s) is/are intended to cover not only the exemplary embodiments of the present invention, but also various alternatives, modifications, equivalents and other embodiments, which may be included within the spirit and scope of the invention as defined by the appended claims.

Exemplary embodiments of the present application will be described more fully hereinafter with reference to the accompanying drawings, in which exemplary embodiments of the invention are shown. As those skilled in the art would realize, the described embodiments may be modified in various different ways, all without departing from the spirit or scope of the present invention.

To clarify the present invention, parts that are not related to the description will be omitted, and the same elements or equivalents are referred to with the same reference numerals throughout the specification.

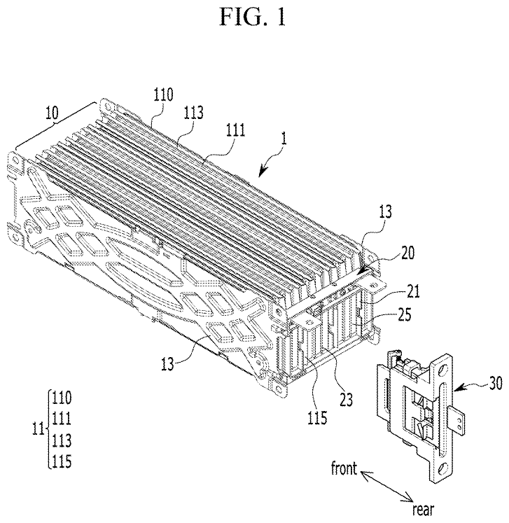

FIG. 1 illustrates assembling of a battery module by use of an apparatus of assembling a battery module according to various exemplary embodiments of the present invention.

Referring to FIG. 1, an apparatus 30 for assembling a battery module according to various exemplary embodiments of the present invention is applied to assemble a cell stack 10 including a plurality stacked battery cells 11 and a conduction block 20 having busbars 25 electrically connected to cell leads 115 of the plurality of battery cells 11.

The battery cell 11 includes a negative electrode plate 110, a positive electrode 111, and a separator 113 located between the negative electrode plate 110 and the positive electrode 111.

A negative electrode lead 115 is provided on the negative electrode plate 110, and a positive electrode lead 115 is provided on the positive electrode 111.

The negative electrode plate 110, the separator 113, and the positive electrode 111 are sequentially stacked in the battery cell 11, and the battery cell 11 is wrapped by a pouch.

At the present time, the negative electrode lead 115 and the positive electrode lead 115 are exposed to an outside of the pouch.

The cell stack 10 is formed by stacking a plurality of battery cells 11, and a fixing plate 13 is disposed at each side in a width direction of the cell stack 10.

Furthermore, the conduction block 20 is assembled at both end portions in length direction of the battery cell 11.

The conduction block 20 is coupled with the fixing plate 13 at both sides, and forms a penetration hole 23 through which each cell lead 115 of the battery cells 11 may penetrate to be exposed outside.

The conduction block 20 includes the busbars 25 connected to cell leads 115 respectively.

Optionally, a partition wall 21 may be located between adjacent busbars 25.

The conduction block 20 is electrically connected to the battery cell 11 through the cell lead 115 and the busbar 25.

The busbar 25 and the cell lead 115 are joined by laser bonding to form electrical contact therebetween.

An apparatus 30 for assembling a battery module according to various exemplary embodiments of the present invention is applied to assemble the cell stack 10 and the conduction block 20.

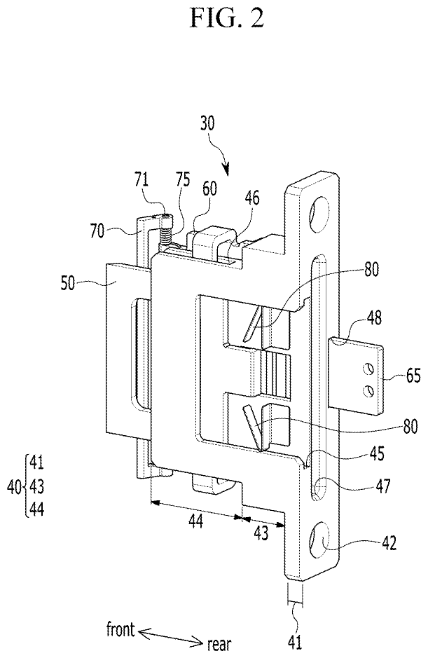

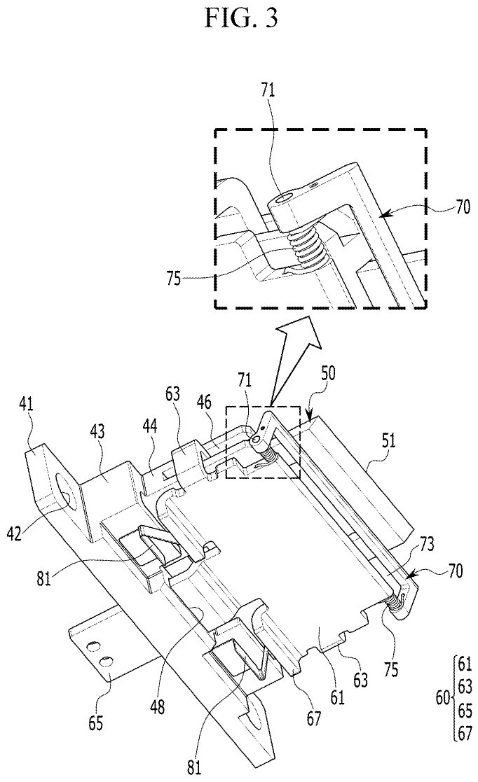

FIG. 2 is a schematic diagram showing a first side of an apparatus of assembling a battery module according to various exemplary embodiments of the present invention. FIG. 3 is a schematic diagram of an opposite side of an apparatus of assembling a battery module according to various exemplary embodiments of the present invention.

Referring to FIG. 2 and FIG. 3, an apparatus 30 for assembling a battery module according to various exemplary embodiments of the present invention includes a jig base 40, a bending knife 50, a jig plate 60, and a bending link 70.

Hereinafter, reference directions of a front-rear direction thereof, a left and right direction thereof, and vertical direction are made with reference to FIG. 2, a portion facing upward is called an upper portion, an upper end portion, an upper surface, and an upper end portion, a portion facing downward is called a lower portion, a lower end portion, a lower surface, and a lower end portion.

The above definition of reference directions has relative meanings, and may not necessarily limited thereto since directionality may vary depending on reference positions of the exemplary apparatus or constituent parts employed therein

In addition, hereinafter, an “end (one end, another end, and the like)” may be defined as any one end or may be defined as a portion (one end portion, another end portion, and the like) including that end.

The jig base 40 may be mounted on a robot arm that operates the apparatus 30.

The jig base 40 includes a flange 41 to be mounted on the robot arm, and the flange 41 may form a fastening hole 42 to fasten the jig base 40 to the robot arm, e.g., by bolt engagement.

The jig base 40 includes a rear base 43 integrally formed with the flange 41 and a front base 44 integrally formed with the rear base 43. The front base 44 is smaller in a width, i.e., in vertical direction in FIG. 2, than the rear base 43.

A mounting portion 45 is formed in the jig base 40 to penetrate the front base 44 and the rear base 43.

Furthermore, a coupling groove 46 is formed at both side surfaces of the front base 44 of the jig base 40.

The coupling groove 46 may be formed along both the side surfaces of the front base 44.

A slot 47 is formed in the jig base 40, and the slot 47 penetrates through the rear base 43 and the front base 44.

The slot 47 is formed between the jig plate 60 and the bending knife 50 through the rear base 43.

Furthermore, in the jig base 40, a mounting hole 48 is formed through the rear base 43 and the flange 41.

The bending knife 50 is provided in the jig base 40.

The bending knife 50 is inserted into the mounting portion 45 of the jig base 40, and elastically supported toward a front direction thereof, by a first plate spring 80 mounted on a first side surface of the rear base 43.

The bending knife 50 is configured to pressurize an edge portion of the cell lead 115 toward the busbar 25 by the slanted surface, by being elastically supported by the first plate spring 80.

Furthermore, the bending knife 50 is formed in a plate shape, and includes a frontal surface 51 which is formed to be inclined to form a slanted surface.

The bending knife 50 has a width corresponding to the length of the cell lead 115 of the battery cell 11, and may contact with the cell lead 115 through the frontal surface 51.

Furthermore, the jig plate 60 is provided external to the jig base 40, and configured to slide along the jig base 40 in the front and rear direction thereof.

The jig plate 60 includes a body 61 of the plate shape formed corresponding to the jig base 40.

The jig plate 60 includes coupling portions 63 that integrally extend from and are bent at both sides of the body 61.

The jig plate 60 is coupled with the coupling grooves 46 at both the side surfaces of the front base 44, through the coupling portions 63.

Furthermore, the jig plate 60 includes a protrusion portion 65 which is formed integral with and protruding from a rear center portion of the body 61.

The jig plate 60 is provided to penetrate the mounting hole 48 of the rear base 43, through the protrusion portion 65.

At the present time, the protrusion portion 65 may be operated by being connected to a separate robot.

Furthermore, the jig plate 60 includes a supporting portion 67 that integrally extends from and is bent at both real end portions of the body 61.

The jig plate 60 is elastically supported by a second plate spring 81 mounted on a second side surface of the rear base 43, through the supporting portion 67.

The bending link 70 is mounted on a frontal end portion of the jig plate 60.

The bending link 70 is hinge-engaged with a frontal end portion of the jig plate 60, and configured to rotate until becoming perpendicular to the jig plate 60 while pressurizing the cell lead 115 toward the busbar 25 by the elastic force of the second plate spring 81, when contacting with the cell lead 115. When the bending link 70 becomes perpendicular to the jig plate 60, the bending link 70 contacts with the jig base 40, stopping the rotation.

The bending link 70 is formed in parallel with the jig plate 60 and the bending knife 70, and includes hinge portions 71 bend at both end portions of the bending link 70. The hinge portions 71 is hinge-engaged with a frontal end portion of the body 61 of the jig plate 60 such that the bending link 70 may be rotatable.

Furthermore, by being hinge-engaged with the body 61 of the jig plate 60, the bending link 70 forms a hollow space 73 with respect to the body 61 of the jig plate 60, i.e., between the bending link 70 and the body 61 of the jig plate 60.

At the present time, when pressurizing the cell lead 115, the bending link 70 is rotated to be perpendicular to the jig plate 60, by contacting with the cell lead 115. In the instant state, the hollow space 73 and the slot 47 of the jig base 40 becomes in-line perpendicular to the cell stack 10.

In the present state, a laser beam B may be radiated toward the hollow space 73 through the slot 47 to weld the cell lead 115 to the bus bar 25 through the hollow space 73.

The bending link 70 includes return springs 75 mounted on the hinge portions 71

The return spring 75 may apply a pressurizing force on the cell lead 115 bent by the bending knife 50 to better contact with the busbar 25, and may apply a return force to the bending link 70 when a welding process is finished.

An exemplary method for assembling a battery module is for assembling the cell stack 10 including the plurality stacked battery cells 11 and the conduction block 20 having the busbar 25 electrically connected to the cell leads 115 of the plurality of battery cells 11.

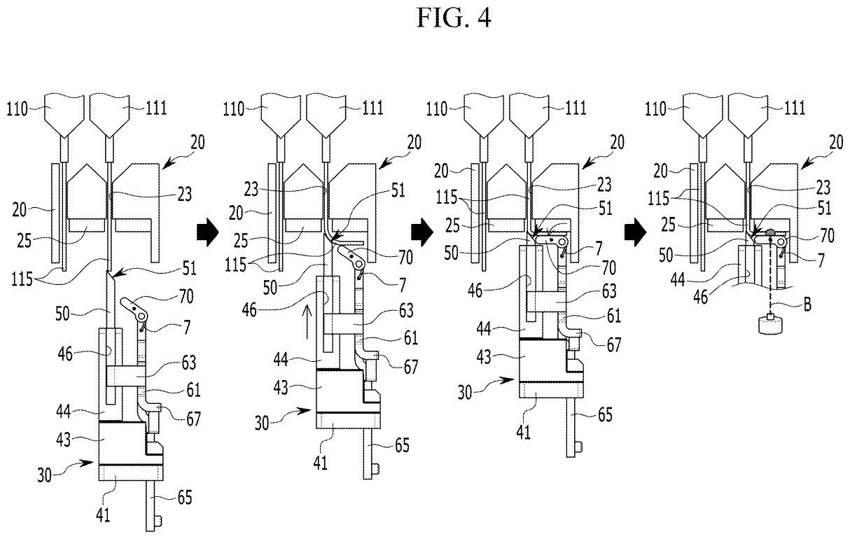

FIG. 4 is a drawing showing a method for assembling a battery module according to various exemplary embodiments of the present invention.

Referring to FIG. 4, first, the jig base 40 is moved toward the battery cell 11.

After moving the jig base 40 toward the battery cell 11 by a preset distance, the cell lead 115 is primarily bent with respect to the busbar 25 by the bending knife 50.

At the present time, the frontal surface 51 of the bending knife 50 that forms the slanted surface is positioned corresponding to an end portion of the cell lead 115 at an edge portion of the busbar 25.

Furthermore, the frontal surface 51 of the bending knife 50 pressurizes the end portion of the cell lead 115 to bend according to the slanted surface, e.g., to the right in FIG. 4. In the instant case, the frontal surface 51 of the bending knife 50 pressurizes the end portion of the cell lead 115 to bend according to the slanted surface.

Subsequently, the jig base 40 is further moved toward the battery cell 11, and thus, the cell lead 115 is secondarily bent toward the busbar 25 by the bending link 70, forming a tight contact with the busbar 25.

At the present time, by the further movement of the jig base 40 toward the battery cell 11, the bending knife 50 retracts toward the jig base 40 while pressurizing the cell lead 115 by the first plate spring 80 supporting the bending knife 50 toward the cell lead 115.

The jig base 40 is moved toward the battery cell 11 until the bending link 70 becomes perpendicular to the body 61 of the jig plate 60, i.e., until the bending link 70 becomes parallel to the busbar 25. During the present process, the cell lead 115 further pressurized toward the busbar 25, by the elastic forces of the second plate spring 81 and the return spring 75. When the bending link 70 becomes perpendicular to the jig plate 60, the bending link 70 contacts with the jig base 40, stopping the rotation.

In the present state, the bending link 70 may pressurize and entire front surface of the cell lead 115, forming a fully tight contact between the cell lead 115 and the busbar 25.

Finally, a laser beam B is radiated through the hollow space 73 between the bending link 70 and the jig plate 60, and thereby the cell lead 115 is welded to the busbar 25.

That is, the laser beam B is radiated through the slot 37 of the jig base 40 positioned in-line with the hollow space 73 when the bending link 70 becomes perpendicular to the jig plate 60 to contact with the jig base 40.

Thereafter, the jig base 40 is retracted, and the bending link 70 returns to the initial state by the return spring 75 mounted on the hinge portion 71 of the bending link 70 and the body 61 of the jig plate 60.

Therefore, in an apparatus and method for assembling a battery module according to various exemplary embodiments of the present invention, the cell lead 115 of the battery cell 11 is bent toward the busbar 25 and forced to tightly contact with the busbar 25 at the same time, reducing a cycle time for the welding process.

According to an apparatus and method for assembling a battery module according to various exemplary embodiments of the present invention, an overall process may be simplified, reducing investment costs and improving productivity.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. An apparatus for assembling a battery module, the apparatus being configured to assemble a cell stack including a plurality stacked battery cells and a conduction block having a busbar electrically connected to cell leads of the plurality of battery cells, the apparatus comprising:
a jig base including a rear base and a front base integrally formed with the rear base;
a bending knife which is slidably provided in the jig base, includes a frontal surface to selectively contact with at least one of the cell leads, and is elastically supported by a first plate spring formed on a first side surface of the rear base;
a jig plate provided external to the jig base and configured to slide along the jig base in a predetermined direction; and
a bending link pivotally engaged with a frontal end portion of the jig plate and configured to rotate in a predetermined angle with respect to the jig plate while pressurizing the at least one of the cell leads.

2. The apparatus of claim 1, wherein the frontal surface of the bending knife is formed to be inclined to form a slanted surface.

3. The apparatus of claim 2, wherein the bending knife is configured to pressurize an edge portion of the at least one of the cell leads toward the busbar by the slanted surface, by being elastically supported by the first plate spring.

4. The apparatus of claim 1, wherein the jig plate is coupled with a coupling groove on first and second side surfaces of the front base by a coupling portion that integrally extends from and are bent at a first side and a second side of a body of a plate shape formed corresponding to the jig base.

5. The apparatus of claim 4, wherein the jig plate is provided to penetrate a mounting hole formed through the rear base, through a protrusion portion formed integral with and protruding from a rear center portion of the body.

6. The apparatus of claim 4, wherein the jig plate is elastically supported by a second plate spring formed on a second side surface of the rear base, through a supporting portion that integrally extends from and is bent at both real end portions of the body.

7. The apparatus of claim 4, wherein the bending link is pivotally engaged with a frontal end portion of the jig plate and forms a hollow space with respect to the frontal end portion of the jig plate.

8. The apparatus of claim 7, wherein when pressurizing the at least one of the cell leads, the bending link is configured to rotate to be perpendicular to the jig plate by contacting with the at least one of the cell leads, to allow welding of the at least one of the cell leads to the bus bar by laser beam through the hollow space.

9. The apparatus of claim 8,
wherein a slot is formed between the jig plate and the bending knife through the rear base, and
wherein the hollow space and the slot of the jig base become in-line perpendicular to the cell stack when the bending link is perpendicular to the jig plate.

10. The apparatus of claim 4, wherein the bending link includes a spring mounted on a hinge portion between the bending link and the jig plate.

11. A method for assembling a battery module for assembling a cell stack including a plurality stacked battery cells and a conduction block having a busbar electrically connected to cell leads of the plurality of battery cell, the method comprising:
bending at least one of the cell leads with respect to the busbar by a bending knife by moving a jig base toward the battery cell;
bending the at least one of the cell leads toward the busbar by a bending link by further moving the jig base toward the battery cell; and
welding the at least one of the cell leads to the busbar by radiating a laser beam through a hollow space between the bending link and a jig plate.

12. The method of claim 11, wherein, in the bending the at least one of the cell leads with respect to the busbar,
positioning a frontal surface of the bending knife that forms a slanted surface, to an end portion of the at least one of the cell leads; and
pressurizing, by the frontal surface of the bending knife, the end portion of the at least one of the cell leads to bend according to the slanted surface.

13. The method of claim 11, wherein, in the bending the cell lead toward the busbar,
retracting the bending knife toward the jig base while pressurizing the at least one of the cell leads by a first plate spring supporting the bending knife toward the cell lead.

14. The method of claim 11, wherein, in the bending the at least one of the cell leads toward the busbar, moving the jig base toward the at least one of the cell lead until the bending link becomes perpendicular to the jig plate to contact with the jig base.

15. The method of claim 11, wherein, in the bending the at least one of the cell leads toward the busbar, pressuring the at least one of the cell leads toward the busbar by the bending link by a second plate spring supporting the jig plate.

16. The method of claim 11, wherein, in the welding the at least one of the cell leads to the busbar, radiating the laser beam through a slot of the jig base positioned in-line with the hollow space when the bending link becomes perpendicular to the jig plate to contact with the jig base.

17. The method of claim 11, further including, after the welding the at least one of the cell leads to the busbar, returning the bending link to an initial state by a spring mounted on a hinge portion between the bending link and the jig plate.

18. The method of claim 11,
wherein the jig plate is provided external to the jig base and configured to slide along the jig base in a predetermined direction,
wherein the bending knife is slidably provided in the jig base, includes a frontal surface to selectively contact with the at least one of the cell leads, and is elastically supported by a first plate spring formed on a side surface of the jig base, and
wherein the bending link is pivotally engaged with a frontal end portion of the jig plate and configured to rotate in a predetermined angle with respect to the jig plate while pressurizing the at least one of the cell leads.
